(19) United States
(12) Patent Application Publication
(10) Pub. No.: US 2005/0111481 A1
(43) Pub. Date: May 26, 2005

(54) [METHOD AND SYSTEM FOR TRANSMITTING DATA THROUGH MULTI-PATH BUS]

(76) Inventor: Chia-Chun Lin, Nantou County Nantou City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,608

(22) Filed: May 18, 2004

(30) Foreign Application Priority Data
Nov. 20, 2003 (TW) 92132501

(51) Int. Cl. H04L 12/26

(52) U.S. Cl. 370/462; 370/252

(57) ABSTRACT

A method and system thereof for transmitting data through multi-path bus is provided. Where a data block is divided into data segments, which are transmitted through transmission channels, and are received and assembled at the receiving end. Therefore, the present invention provides higher flexibility in transmission rate and circuit board area. Furthermore, when there is no data segment to be transmitted, simultaneous transmission for the being-transmitted data segment through another channel is allowed. Hence, transmission failure or transmission delay is avoided when any of the data transmission channels performs poorly.

### CROSS REFERENCE TO RELATED APPLICATIONS

This application claims the priority benefit of Taiwan application serial no. 92132501, filed Nov. 20, 2003.

### BACKGROUND OF INVENTION

1. Field of the Invention

This invention generally relates to a method and a system for transmitting data, and more particularly to a method and a system for transmitting data through multi-path bus.

2. Description of Related Art

As information technology advances, distributive-processing system has already become a common choice in computer systems. Therefore, to transmit data stably and rapidly between devices through buses upon different purposes is one of the significant factors to determine system performance.

Serial bus data transmission and parallel bus data transmission are two examples of conventional art for transmitting data through bus. In serial bus data transmission, as depicted in FIG. 1, data block is transmitted thereby one bit at a time. Whereas in parallel bus data transmission, as depicted in FIG. 2, data block is transmitted thereby N bits at a time via buses L1˜LN. Hence, transmission rate of the parallel bus is higher than that of the serial bus.

However, parallel bus data transmission circuitry requires more board area than serial bus data transmission circuitry does. To reduce circuit board area, number of buses has to be reduced and transmission frequency has to be raised. However, due to the difference between circuit layouts, it is more difficult to synchronize signals when the transmission frequency is raised. Furthermore, neither of the two conventional methods of data transmission works if any one of the data buses fails.

### SUMMARY OF INVENTION

The present invention provides a method for transmitting data through a multi-path bus in a transmission system having a plurality of data transmission channels, such as Universal Serial Buse (USB) or optical fiber channels. The method follows the steps. Firstly a data block is divided into a plurality of data segments by a transmitting end of a transmission system, which are transmitted through the data transmission channels. Secondly, the data segments are received at a receiving end of the transmission system through the data transmission channels and are assembled as the data block thereafter.

In the above method, a size and quantity of the data segments are determined as the transmitting end and the receiving end communicate through one of the channels before transmitting the data block.

In the above method, the transmitting end of the transmission system maintains the statuses of the data segments, where the statuses include transmitting channel idling or being in-use, and data segments being transmitted, being-transmitted, or to-be-transmitted, for example. Therefore, certain data segment is transmitted via certain data transmission channel according to the status thereof.

When one of the data transmission channels is idling and none of the data segment is to be transmitted, the idling data transmission channel simultaneously takes over the data segment under transmission, if any, so as to avoid delayed or failed transmission due to poor data transmission channel performance.

During transmission, the data segments are numbered by the transmitting end, and are assembled back to the data block at the receiving end based on the numbering.

The present invention further provides a multi-path bus data transmission system comprised of multi-path bus data transmitting ends and receiving ends.

Wherein the multi-path bus data transmitting end includes a plurality of transmitting end transceivers and a plurality of transmitting end arbitors. The transmitting end transceivers is for providing a plurality of data transmission channels, and the transmitting arbitors are coupled to the transceivers so that the data block to be transmitted is sliced into a plurality of data segments that are to be transmitted via the channels.

Wherein the multi-path bus data receiving end includes a plurality of receiving end transceivers and a plurality of receiving end arbitors. The receiving end transceivers provide a plurality of data transmission channels, and the receiving end arbitors are coupled to the transceivers so that the data segments are received via the data transmitting channels and are assembled back to the data block accordingly.

In the present invention, a valid size and quantity of the data segments are responded by the receiving end arbitor to the transmitting end arbitor, upon request, through one of the data transmission channels before the data segments are transmitted.

In the present invention, the statuses of the data segments (e.g. transmitted, being-transmitted, or will-be-transmitted) and the data transmission channels (e.g. the channel being idle or in-use) are maintained, upon which statuses one of data transmission channels for transmitting the data segments is determined by the transmitting end arbitor.

When the statuses of one of the data transmission channels being idle, none of the data segments is to be transmitted, and one of the data segments is being transmitted are determined at the transmitting end arbitor, simultaneous data transmission of data segments is operate thereby through the idling data transmission channel in this present inventions. Hence, the data segment is free of delay or failure when a certain channel poorly performs.

It is noted that both transmission rate and circuit board area, yet not exclusively, are rather flexible in this present invention in light of the above. Since a data block is divided into data segments and is transmitted through transmission channels with multi-path bus according to the method and system thereof, and the data segments are received at the receiving end and are assembled back to the data bock thereat. Further, when there is no data segment for transmission, the ongoing transmitting data segment is switched to another channel for transmission. Hence, the data segment is free of being delayed or being not transmitted when a certain channel poorly performs.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a diagram illustrating a serial bus data transmission in accordance with prior art technology.

FIG. 2 is a diagram illustrating a parallel bus data transmission in accordance with prior art technology.

FIG. 3 is a block diagram illustrating the system for transmitting data through a multi-path bus in accordance with a preferred embodiment of the present invention.

FIG. 4 is a flow chart illustrating the transmitting end for transmitting data through a multi-path bus in accordance with a preferred embodiment of the present invention.

FIG. 5 is a flow chart illustrating the receiving end for receiving data through a multi-path bus in accordance with a preferred embodiment of the present invention.

FIG. 6 is a block diagram illustrating the system for transmitting data through a multi-path bus with optical fibers as the transmission channels in accordance with a preferred embodiment of the present invention.

FIG. 7 is a block diagram illustrating the system for transmitting data through a multi-path bus with universal serial buses as the transmission channels in accordance with a preferred embodiment of the present invention.

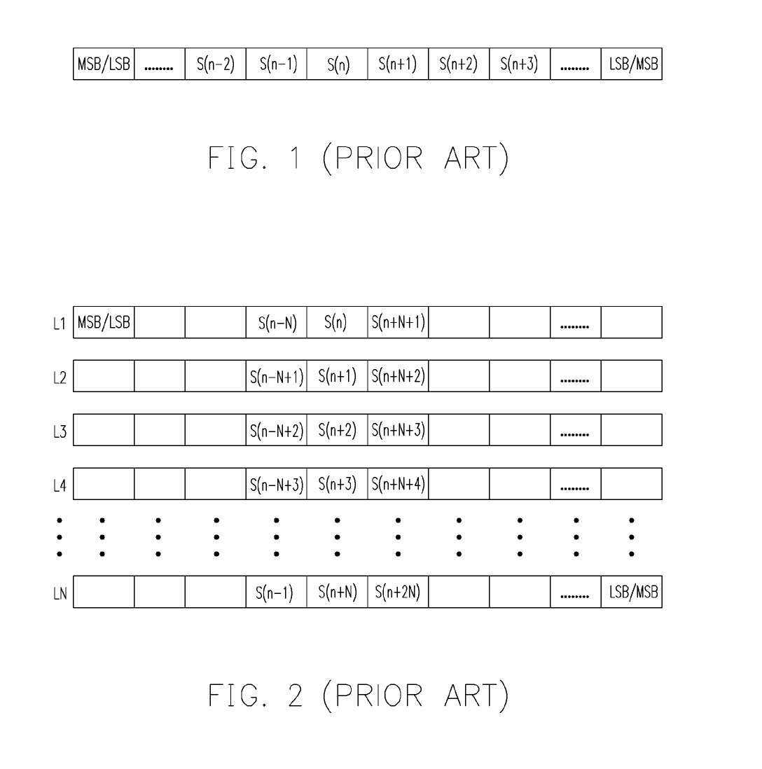

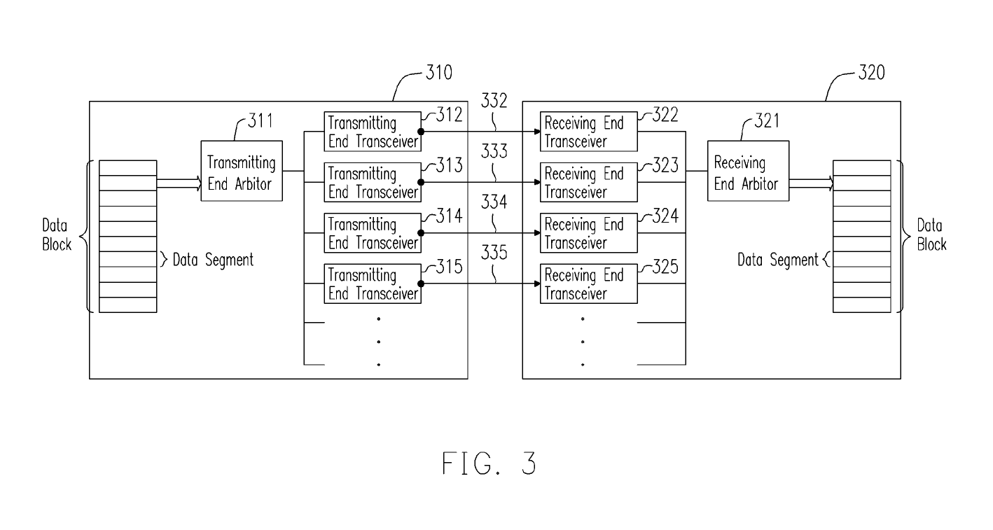

### DETAILED DESCRIPTION

FIG. 3 is a block diagram illustrating the system for transmitting data through a multi-path bus in accordance with a preferred embodiment of the present invention. As depicted in FIG. 3, the multi-path bus data transmission system 300 includes a transmitting end 310 and a receiving end 320.

The transmitting end 310 includes a transmitting end arbitor 311 and transmitting end transceivers 312, 313, 314, and 315. The receiving end 320 includes a receiving end arbitor 321, and receiving end transceivers 322, 323, 324, and 325. It should be noted that the quantity of the transmitting end transceivers and receiving end transceivers depends on the quantity of the data transmission channels. For example, FIG. 3 provides four channels 332, 333, 334, and 335. Therefore, it requires four transmitting end transceivers and four receiving end transceivers. Further, the data transmission channels 332, 333, 334, and 335 are not limited to serial buses, i.e. parallel buses also apply.

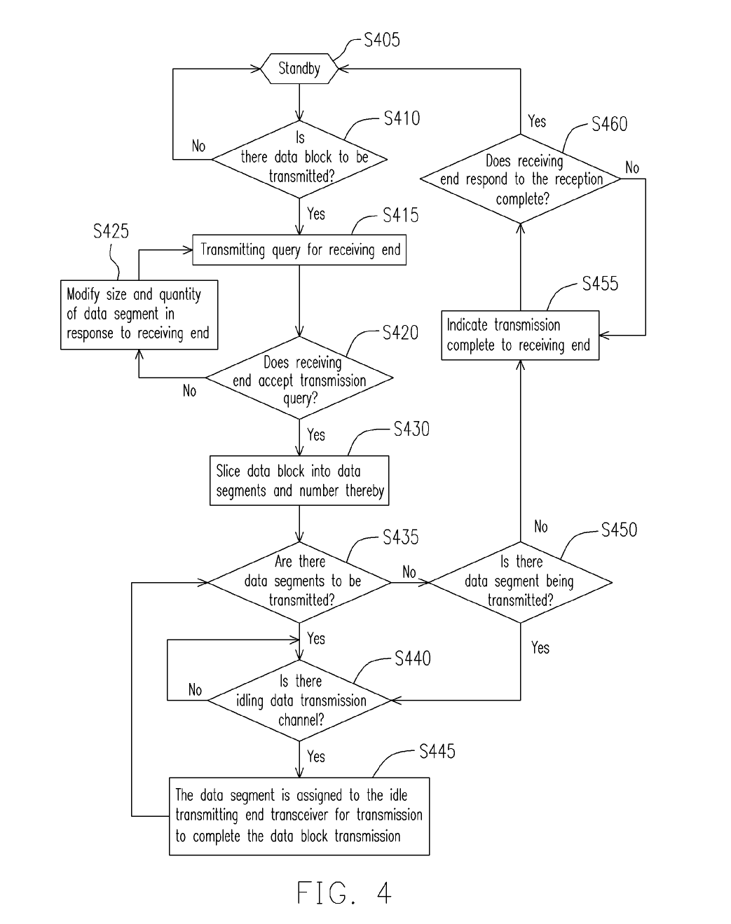

As shown in FIG. 3, the transmitting end arbitor 311 is coupled to the transmitting end transceivers 312, 313, 314, and 315 so that the ongoing data block is divided into data segments and are transmitted through the data transmission channels 332, 333, 334, and 335. A flow chart for transmitting data is illustrated in FIG. 4 and is demonstrated as follows.

When the system is in standby status (S405), the transmitting end arbitor 311 determines whether there is a data block to be transmitted (S410) or not. If there is, the transmitting end requests the receiving end for the size and quantity of the data segments to be transmitted through an idling data transmission channel (S415). Then the transmitting end listens to a response of the receiving end (S420). If the receiving end indicates “not ready” for receiving data segments, the transmitting end readjusts the size and quantity of the data segments (S425). If the receiving end indicates ready for receiving, the data block is divided into data segments, which are numbered accordingly (S430).

Then in S435 whether there is a to-be-transmitted data segment ready for transmission. If there is, an idling data transmission channel is determined in S440. The data segments are thus respectively assigned to the idling transmitting end transceivers for transmission subsequently and data block is completely transmitted thereby (S445).

Whereas if there is no data segment to be transmitted in S435, whether there is a being-transmitted data segment is then determined in step S450. If there is, and as well is an idling data transmission channel (determined in S440), this being-transmitted data segment is also assigned to the idling transmitting end transceiver for simultaneous transmission (S445). Hence, the data segment is free of delayed or failed transmission when a certain channel poorly performs. When a transmission completion is determined in step S450, a transmission complete message is transmitted to the receiving end (S455) and the transmitting end listens to a correspondence from the receiving end (S460), and the system returns to standby status thereafter (S405).

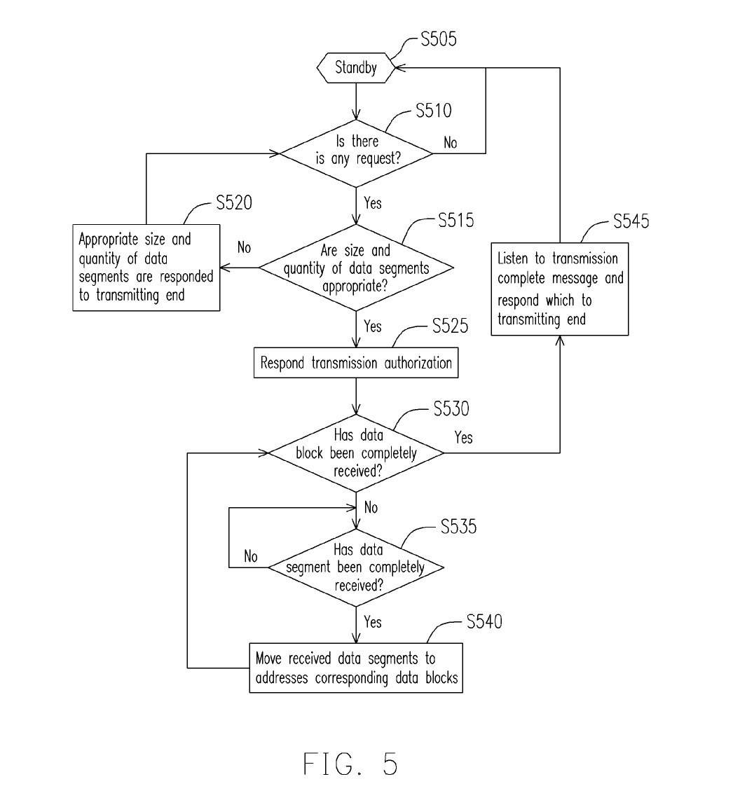

Referring to FIG. 3, the receiving end arbitor 321 is coupled to the receiving end transceivers 322, 323, 324, and 325 receives the data segments through the data transmission channels 332, 333, 334, and 335, whereat the receiving end arbitor 321 the data block is restored. The flow chart for receiving data is illustrated in FIG. 5 and is demonstrated as follows.

When the system is at standby status (S505), the receiving end arbitor 311 determines whether there is a request being received from the transmitting end (S510) or not. If there is, the receiving end determines whether the size and the quantity of the data segments that are to be transmitted are valid (S515). If not valid, a proper size and quantity of the data segments are corresponded to the transmitting end (S520). As a size and a quantity of data segments are agreed by the transmitting and receiving ends, an authentication message is responded to the transmitting end thereafter (S525).

Then the receiving end arbitor determines whether the data block has been completely transmitted or not (S530). If not, the receiving end listens to the data segments and the corresponding numbers (S535), and the data segments are moved to corresponding addresses of the data block accordingly (S540). Since the data block is completely received after data segments are received and moved, the data transmission transaction is accomplished as transmission completion is indicated and responded to the transmitting end. (S545).

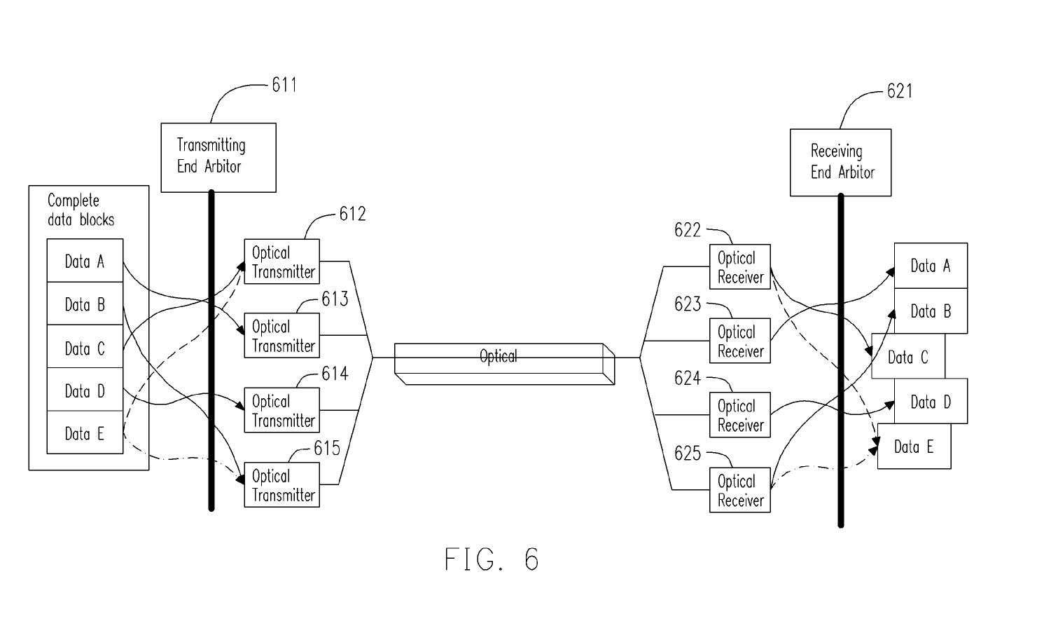

FIG. 6 illustrates the system for transmitting data through a multi-path bus with optical fibers as transmission channels. Referring to FIG. 6, the transmitting end includes a transmitting end arbitor 611 and optical transmitters 612, 613, 614, and 615. The receiving end includes a receiving end arbitor 621 and optical receivers 622, 623, 624, and 625. The data block is divided into data A, data B, data C, data D, and data E at the transmitting end arbitor 611, and are transmitted through the optical transmitters 612, 613, 614, and 615 respectively to the receiving end. The data A, data B, data C, data D, and data E are received at the receiving end arbitor 621 through the optical receivers 622, 623, 624, and 625, and are assembled into the data block. The operation is described as follows.

Firstly, the size and the quantity of the data segments are determined via communication between the transmitting end arbitor 611 and the receiving end arbitor 621 through one of the optical transmitters 612, 613, 614, and 615 and one of the optical receivers 622, 623, 624, and 625. Then the data block is divided into the data segment data A, data B, data C, data D, and data E, which are numbered by the transmitting end arbitor 611. The data A, data B, data C, and data D are thus sequentially assigned to the idling optical transmitters 612, 613, 614, and 615 for transmission by the transmitting end arbitor 611, and statuses of the optical transmitters are switched to “in use” thereby. Furthermore, the statuses of the data A, data B, data C, and data D are changed to “being-transmitted” and the status of the data E stays as “to-be-transmitted”.

Meanwhile, the statuses of the optical receivers 622, 623, 624, and 625 are changed from “idle” to “in use” by the receiving end arbitor 621 as well. If the transmission completion of data C is responded by the optical receiver 622, the statuses of the optical transmitter 612 and the optical receiver 622 are changed to “idle” by the transmitting end arbitor 611 and the receiving end arbitor 621, respectively. The status of data C is changed to “transmitted” by the transmitting arbitor 611 and data E is assigned to the idling optical transmitter 612 for transmission. Then the status of the optical transmitter 612 is switched to “inuse” whereas the status of the data E switched to “being-transmitted”.

If the data transmission channel between the optical transmitter 612 and the optical receiver 622 is interfered so that data C is transmitted poorly, and if the data B has been transmitted via the optical transmitter 615 and the optical receiver 625 as statuses of which are changed to “idle”, the data E is assigned to the idling optical transmitter 615 for transmission by the transmitting end arbitor 611. If the data E is completely received by the optical receiver 625 and a complete transmission message is responded accordingly, the receiving operation of the optical receiver 622 is cancelled by the receiving end arbitor 621, and a transmission complete message is send to the transmitting end thereafter. A transmission completion is verified by the transmitting end arbitor 611 a transmission thereof is cancelled by the optical transmitter 612.

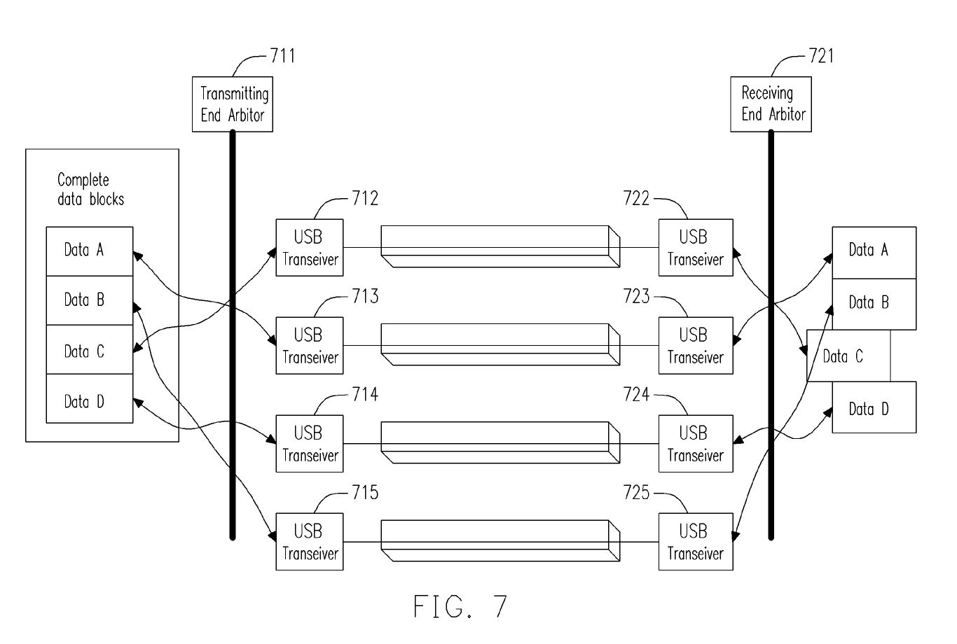

FIG. 7 illustrates the system for transmitting data through a multi-path bus with universal serial buses (USB) as transmission channels. Referring to FIG. 7, the transmitting end includes a transmitting end arbitor 711 and USB transceivers 712, 713, 714, and 715. Where the receiving end includes a receiving end arbitor 721 and USB transceivers 722, 723, 724, and 725. The data block is divided into data A, data B, data C, and data D, which are transmitted through the USB transceivers 712, 713, 714, and 715 respectively to the receiving end. The data A, data B, data C, and data D are received at the receiving end arbitor 721 through the USB transceivers 722, 723, 724, and 725, and are assembled into the data block. The operation thereof is similar to that of FIG. 6, thus is not repeated herein.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. said data segments being received and assembled to said data block at a receiving end of said transmission system through said data transmission channels.

2. The method of claim 1 further comprising a size and a quantity of said data segments being determined upon communication between said transmitting end and said receiving end through said data transmission channels.

3. The method of claim 1 further comprising statuses of said data transmission channels and said data segments being maintained by said transmitting end of said transmission system, and one of said data transmission channels being determined to transmit said data segments based on statuses of said data transmission channels and statuses of said data segments.

4. The method of claim 3 further comprising said data segment that is under transmission being simultaneously transmitted via at least one of said data transmitting channels that is idling when none of said data segments being to-be-transmitted.

5. The method of claim 1, wherein said data segments are numbered by said transmitting end and are assembled to said data bock thereby said receiving end.

6. A system for transmitting data through a multi-path bus in a transmission system, comprising
a plurality of transmitting end transceivers;
a plurality of receiving end transceivers, coupling to said plurality of transmitting end transceivers via a plurality of data transmission channels;
a transmitting end arbitor, coupling to said transmitting end transceivers for dividing a data block into a plurality of data segments for transmission through said data transmission channels; and
a receiving end arbitor, coupling to said receiving end transceivers for receiving said data segments through said data transmission channels and assembling said data segments to said data block.

7. The system of claim 6, wherein a size and a quantity of said data segments are determined upon communication between transmitting end arbitor and said receiving end arbitor through one of said data transmission channels before said data block is transmitted.

8. The system of claim 6, wherein said data segments and said statuses of said data transmission channels are maintained by said transmitting end arbitor, and one of said data transmission channels is determined to transmit said data segments based on said statuses thereof.

9. The system of claim 8, wherein when status of one of said data transmission channels is determined idle by said transmitting end arbitor, none of said data segment is to be transmitted, and one of said data segments is being transmitted, said one of said plurality data segment is transmitted simultaneously by said transmitting end arbitor through said data transmission channel that is determined idle.

10. The system of claim 6, wherein said data segments are numbered by said transmitting end arbitor, and said data block is assembled to said data block accordingly.

11. The system of claim 6, wherein said data transmission channels are optical fiber channels.

12. The system of claim 6, wherein said data transmission channels are universal serial bus channels.

13. A transmitting end for a multi-path bus data transmission, comprising:
a plurality of transmitting end transceivers, providing a plurality of data transmission channels; and
a transmitting end arbitor, coupling to said plurality of transmitting end transceivers, for dividing a data block into a plurality of data segments for transmission through said data transmission channels.

14. The transmitting end of claim 13, wherein a size and a quantity of said data segments are requested by said transmitting end arbitor for said receiving end through one of said data transmission channels before said data block is transmitted.

15. The transmitting end of claim 13, wherein statuses of said data segments are maintained by said transmitting end arbitor, and one of said data transmission channels is determined for transmitting said data segments according to statuses of said data segments and said data transmission channels.

16. The transmitting end of claim 15, wherein said data segment that is under transmission is transmitted simultaneously through said data transmission channel that is idle when status of one of said data transmission channels is determined idle by said transmitting end arbitor, none of said plurality data segments is to be transmitted, and one of said data segments is being transmitted.

17. A receiving end for receiving a data block having a plurality of data segments through a plurality of data transmission channels, comprising:
a plurality of receiving end transceivers, providing said data transmission channels; and
a receiving end arbitor, coupling to said receiving end transceivers, for receiving said data segments through said data transmission channels and assembling said data segments to said data block.

18. The receiving end of claim 17, wherein a size and a quantity of said data segments are requested through one of said data transmission channels, said size and said quantity that are valid are responded by said receiving end.
